(19) United States
(12) Patent Application Publication
(10) Pub. No.: US 2025/0315590 A1
(43) Pub. Date: Oct. 9, 2025

(54) LARGE LANGUAGE MODEL FOR STANDARD CELL LAYOUT DESIGN OPTIMIZATION

(71) Applicant: NVIDIA Corp., Santa Clara, CA (US)

(72) Inventors: Chia-Tung Ho, Santa Clara, CA (US); Haoxing Ren, Austin, TX (US)

(73) Assignee: NVIDIA Corp., Santa Clara, CA (US)

(21) Appl. No.: 19/097,389

(22) Filed: Apr. 1, 2025

Related U.S. Application Data
(60) Provisional application No. 63/574,147, filed on Apr. 3, 2024.
(60) Provisional application No. 63/751,482, filed on Jan. 30, 2025.

(51) Int. Cl. G06F 30/398; G06F 30/31; G06F 30/323; G06F 30/392

(52) U.S. Cl. CPC G06F 30/398; G06F 30/31; G06F 30/323; G06F 30/392

(57) ABSTRACT

System including a circuit layout tool configured to generate a layout or a set of layouts for a circuit, such as a standard cell, based on input cluster constraints, and an automating agent configured to operate a large language model in a Thought-Action-Observation (ReAct) prompting loop to generate the cluster constraints, the cluster constraints formed to optimize performance, power, and area for the circuit.

### CROSS-REFERENCE TO RELATED APPLICATIONS

This application claims priority and benefit under 35 U.S.C. 119 (e) to application serial no. US 63/574,147, titled “Large Language Model (LLM) for Standard Cell Layout Design Optimization”, filed on Apr. 3, 2024, the contents of which are incorporated herein by reference in their entirety. This application also claims priority and benefit under 35 U.S.C. 119 (e) to application serial no. U.S. 63/751,482, “Multi-LLM Agent for Timing QoR Summary Generation”, filed on Jan. 30, 2025, the contents of which are also incorporated herein by reference in their entirety.

### BACKGROUND

A standard cell is a pre-designed, pre-characterized logic or functional block used in the digital integrated circuit (IC) design process. Each standard cell performs a specific logic function, such as an AND gate, OR gate, flip-flop, or other basic combinational or sequential logic functions. These cells are standardized in terms of size, power, and performance characteristics for particular technology nodes (device scales and fabrication processes).

In circuit design, standard cells are used to automate and streamline the process of creating complex ICs. By using a library of pre-defined standard cells, designers can efficiently assemble various functional units of a chip, ensuring consistent performance and reliability. Standard cells facilitate the use of automated design tools, like synthesis and place-and-route tools, which significantly enhance design productivity and reduce time-to-market for new ICs.

Standard cells are essential components of modern digital circuit designs. As process technologies advance toward smaller device sizes, designing a cell with competitive Performance-Power-Area (PPA) while taking into account routability becomes increasingly challenging due to the decreasing number of available routing tracks, increasing complexity of design rules, and strict patterning rules. Conventional tools for automating standard cell layouts struggle to generate highly efficient PPA and routable cell layouts for complex sequential cell designs.

One conventional approach to automating standard cell construction is sequential standard cell synthesis. This mechanism first generates the transistor placement in the cell and then performs routing. Examples of tools utilizing this mechanism include BonnCell and NVCell.

BonnCell utilizes a tree search to explore optimal transistor placement and then formulates a Mixed Integer Linear Programming (MILP) structure for in-cell routing. NVCell utilizes simulated annealing to generate optimal transistor placement, and then operates a genetic algorithm to route the placement, but encounters major challenges on routability for fewer than five available routing tracks in the standard cell.

An enhancement of NVCell (NVCell2) improves routability over NVCell using pin density aware congestion heuristic mechanisms and lattice graph routability models. However, the performance of NVCell2 does not scale well to hundreds of transistors because the model inference needs to be performed for every action in the simulated annealing-based placement algorithm and the cell-level metrics (i.e., cell width and total wirelength are compromised for routabilty).

Another conventional approach utilizes transformer model-based clustering to generate high-quality device cluster constraints, taking into account diffusion sharing and breaks, routability, and design rule constraints (DRCs) for routing metals in the layout of different technology nodes. However, selecting a quality set of layouts to train the transformer clustering model for optimizing PPA and routability of complex sequential cells together has proven challenging. This is because cells with routability issues typically have a larger cell width to reduce transistor pin density, while cells with a more compact layout could exacerbate routability issues. Additionally, there is a limited amount of quality layouts available for training the model in the early development stages of developing the standard cell library for new technology nodes.

Other conventional mechanisms for standard cell synthesis simultaneously places and routes transistors. Conventional mechanisms of this type solve for transistor placement and routing simultaneously using Satisfiability Modulo Theory (SMT). The scalability of mechanisms of this type maybe worse than sequential standard cell synthesis mechanisms on large and complex standard cell designs (i.e., multi-bits flip-flops).

In summary, conventional mechanisms for standard cell synthesis struggle to account for routability and PPA optimization for complex sequential cells in advanced technology nodes.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a standard cell layout system in one embodiment.

FIG. 2 depicts an embodiment of a large language model based agent configured to facilitate standard cell layout.

FIG. 3A depicts an example structure of a netlist topology prompt for an OA333X1 standard cell.

FIG. 3B depicts an exemplary OA333X1 layout.

FIG. 3C depicts an example structure of a physical layout prompt of an OA333X1 standard cell.

FIG. 3D depicts an example structure of a routability report prompt for a SEDFCNQD4T5Z3 standard cell.

FIG. 4A-FIG. 4C depict an exemplary ReAct Thought-Action-Observation loop sequence.

FIG. 5 depicts a parallel processing unit in accordance with one embodiment.

FIG. 6 depicts a general processing cluster in accordance with one embodiment.

FIG. 7 depicts a memory partition unit in accordance with one embodiment.

FIG. 8 depicts a streaming multiprocessor in accordance with one embodiment.

FIG. 9 depicts a processing system in accordance with one embodiment.

FIG. 10 depicts an exemplary processing system in accordance with another embodiment.

### DETAILED DESCRIPTION

Disclosed herein are mechanisms utilizing large language models that generate high-quality cluster constraints to optimize standard cell layout PPA, taking into account the routability of the resulting layouts (e.g., eliminating or minimizing design rule constraints). The disclosed mechanisms may utilize a human designers' expertise and ReAct prompting mechanisms to provide high-quality standard cell layouts for advanced technology nodes.

The disclosed mechanisms may improve standard cell performance, power, and area and may generate potential device clusters for the layout incrementally by simultaneously accounting for the standard cell netlist, cluster constraints from prior iterations, routability, and the physical standard cell layout.

The disclosed mechanisms enable Large Language Models to function as autonomous circuit design agents for reasoning and acting in conjunction with standard netlist tools. Using ReAct, the large language model initiates the generation of subsequent steps with Thought, Action, and Observation sequences.

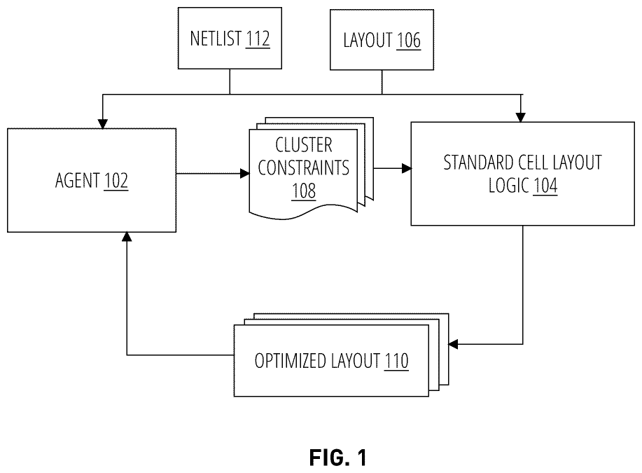

FIG. 1 depicts a standard cell layout system in one embodiment. The system comprises standard cell layout logic 104 configured to process a circuit layout 106 and cluster constraints 108 into an optimized layout 110. The cluster constraints 108 are generated by processing a circuit netlist 112 (e.g., a SPICE netlist), a physical layout 106 for the circuit, and routability 202 results for the layout 106 through an agent 102.

A SPICE netlist is a textual representation of an electronic circuit used by SPICE (Simulation Program with Integrated Circuit Emphasis) simulation tools. It details the components of the circuit and their connections. In a SPICE netlist, each line or group of lines defines an electronic component (such as resistors, capacitors, transistors) and includes parameters such as component value, nodes, and model names. Nodes represent points that define how components are interconnected. The SPICE netlist may also comprise definitions of device models and parameters useful for simulating the behavior of complex components like transistors. The SPICE netlist may be input to a SPICE simulator to analyze the circuit to predict its electrical behavior.

The standard cell layout logic 104 may be configured to optimize the input layout 106 into candidate layouts 110 optimized for performance, power, and area (PPA), while conforming the optimized layouts 110 to routability design rule constraints.

The agent 102 may adjust and fine-tune device cluster constraints 108 incrementally in a feedback loop, based on the netlist layout 106 and an optimized layout 110 selected by a human operator from the previous iteration of the loop, to efficiently optimize PPA and routability concurrently.

Modern Large Language Models (LLMs) have utility across various tasks in language understanding and interactive decision-making, incorporating logic to carry out reasoning and actions. The disclosed mechanisms may comprise a system configured to operate as the agent 102 to adjust the device clustering cluster constraints 108 incrementally, optimizing cell layout PPA and routability with guidance from designers' expertise and ReAct prompting techniques.

ReAct (Reasoning and Acting) prompting is a mechanisms used to enhance the performance of language models by combining verbal reasoning with dynamic task execution. It may be particularly useful for tasks requiring both complex reasoning and interactive steps to achieve a solution. With ReAct prompting, the language model formulates a chain of analysis through step-by-step reasoning, often by breaking down a problem and considering intermediate steps or hypotheses. This facilitates logic tracing and helping ensure the accuracy of conclusions.

Concurrently with reasoning, the model performs actions, such as querying a data source or executing commands, thereby affecting task outcomes. These actions are based on the current state of understanding and the formulated reasoning. ReAct may be carried out over iterative cycles where reasoning informs actions, and actions provide feedback that may refine or alter the reasoning process. This loop continues until a satisfactory solution is achieved. By integrating reasoning with acting, ReAct prompting enables language models to handle complex interactive tasks more effectively than some other prompting mechanisms.

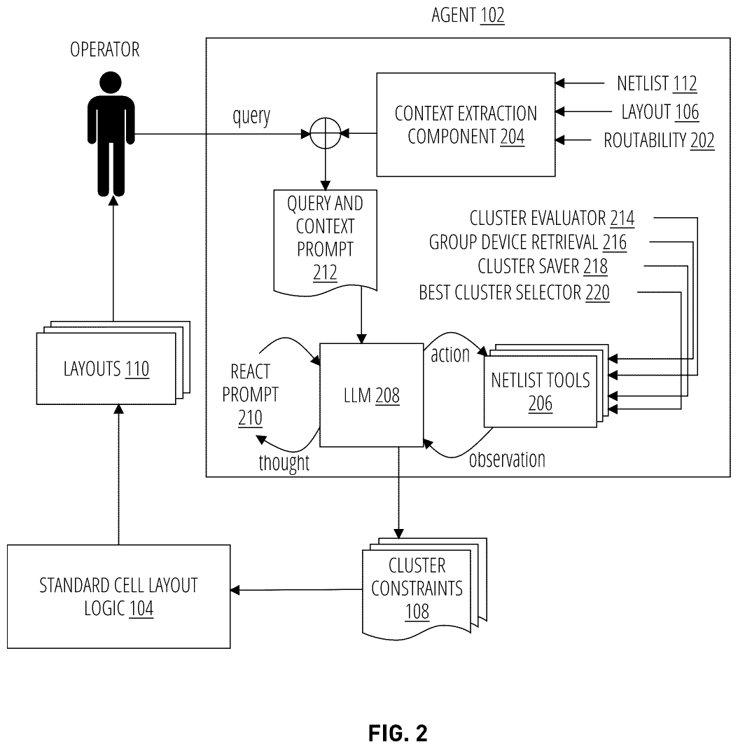

FIG. 2 depicts an embodiment of a large language model-based agent 102 configured to facilitate standard cell layout. The agent 102 may comprises the following components: context extraction components 204 to initiate queries and provide domain knowledge prompts, netlist tools 206 to operate cooperatively with a large language model 208 to generate valid cluster constraints 108, and generation of ReAct prompts 210 for exploring high-quality cluster candidates to enhance the PPA and routability of optimized layout 110 generated by standard cell layout logic 104.

Context extraction and domain knowledge prompts may be provided by, for example a pre-trained machine learning model, a scripted database, or a human operator (e.g., human circuit engineer). A pre-trained machine learning model or scripted database for these purposes may be structured and trained in manners known in the art.

In an initial iteration, the agent 102 inputs an initial layout 106 for a circuit, a netlist 112 for the circuit, routability 202 results for the initial layout, and the corresponding cluster constraints 108. Netlist connects and components may be retained while removing unrelated information (i.e., technology-related manufacturing parameters). Physical layout and routability information may be obtained from commercial Electronic Design Automation (EDA) tools. The context extraction components 204 are operated to generate a query and context prompt 212 comprising domain knowledge for the circuit. The query and context prompt 212 comprises a netlist topology expressed in technology-node-independent descriptions of MOSFETs, initial cluster constraints, standard cell layout, and expert guidance.

ReAct prompts 210 are generated to implement dynamic reasoning by the large language model 208, resulting in creation and adjustment of actions plans. The actions (i.e., grouping MOSFETs, evaluating clusters, etc.) are applied as commands to the netlist tools 206 that return observations, which in turn are applied as prompts to the large language model 208 to generate additional ReAct prompts 210 (thoughts).

The cluster constraint 108 output from the agent 102 are input to standard cell layout logic 104, such as Nvidia's® NVCell tool and open-source tools such as the SMT-based-STDCELL-Layout-Generator (https://github.com/ckchengucsd/SMT-based-STDCELL-Layout-Generator), to generate the PPA and routability optimized layouts 110. An operator working with the agent 102 may repeat this process until the PPA meets design requirements without routability issues.

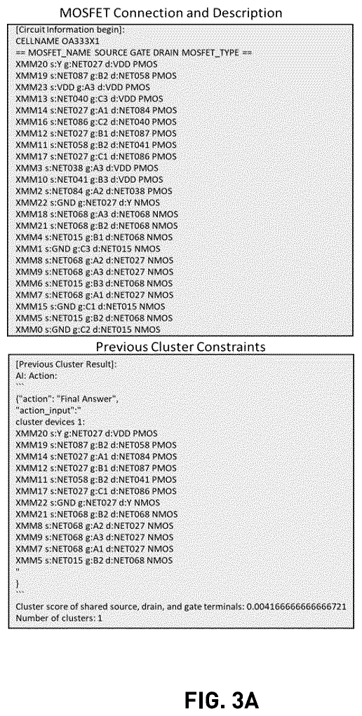

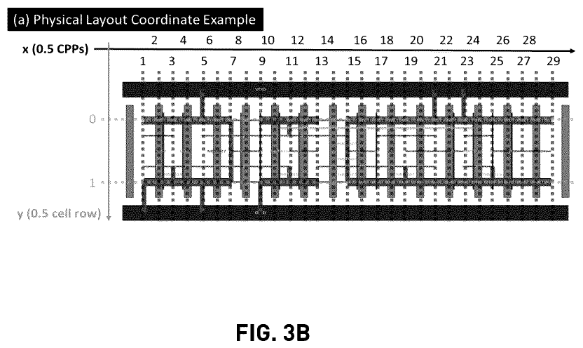

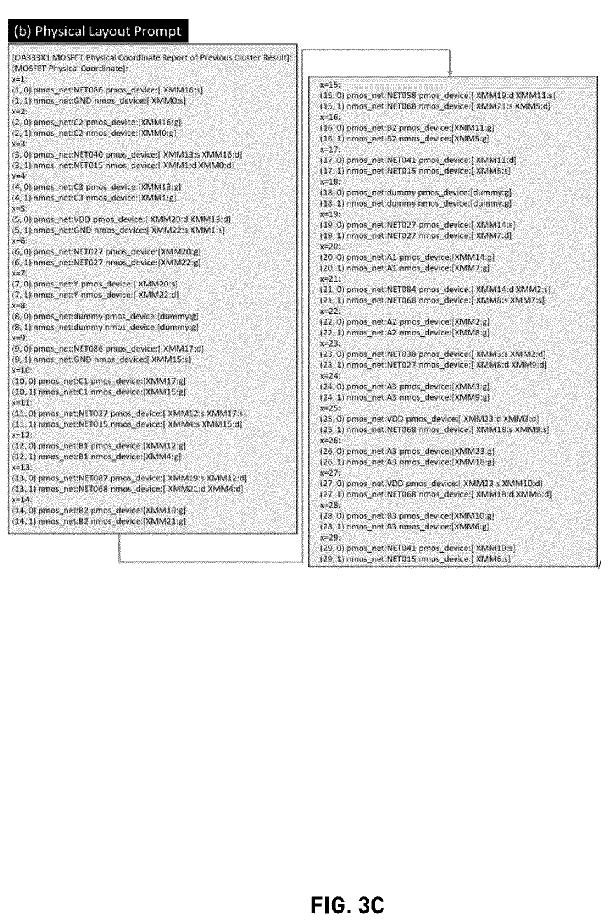

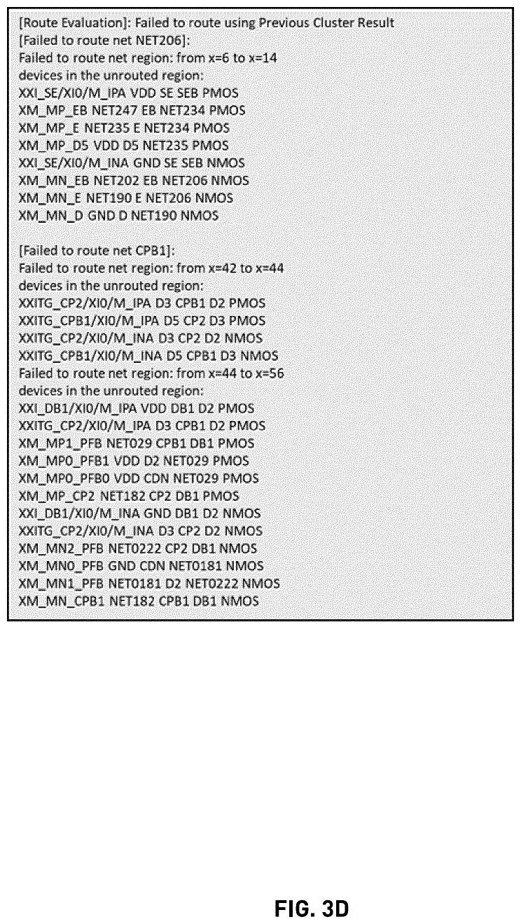

FIG. 3A depicts an example structure of a netlist topology prompt for an OA333X1 standard cell. The exemplary prompt may be generated by one of the context extraction components 204. In addition to the netlist topology prompt, the context extraction components 204 may generate a physical layout prompt (FIG. 3C) and a routability report prompt (FIG. 3D).

The netlist topology prompt comprises MOSFET connections and descriptions for the standard cell as well as previous cluster constraints for the standard cell. In the MOSFET connection and description, each MOSFET device in the netlist is defined using a technology-independent device description format, which comprises a MOSFET name, terminal connections, and the type of MOSFET. A exemplary technology-independent device description format is “MOSFET\_NAME d: DRAIN g: GATE s: SOURCE MOSFET\_TYPE”.

The previous cluster constraints may be defined in a JSON BLOB format with the action labeled as “Final Answer”. A simple cluster score and the number of clusters resulting from the previous cluster constraints may also be included in the netlist topology prompt.

The netlist topology prompt provides context for the large language model 208 to interpret the netlist connections of each device. This interpretation, along with the previous cluster constraints and the simple cluster score of the previous cluster constraints, are utilized by the large language model 208 for subsequent ReAct prompting.

FIG. 3C depicts an example structure of a physical layout prompt of an OA333X1 standard cell. The exemplary prompt may be generated by one of the context extraction components 204. The structure of the exemplary physical layout prompt may be understood in the context of the exemplary OA333X1 layout depicted in FIG. 3B.

The physical layout prompt comprises the placed device locations and net connections of device terminals in the standard cell. The large language model 208 may apply the physical layout prompt to compile the netlist topology and layout together for ReAct prompting.

Referring to the exemplary layout depicted in FIG. 3B, the x-coordinate units are half of the contacted-poly-pitch (CPP) of the layout, and the y-coordinate units are half the cell row height. As a result, there are 29 columns and 2 rows in the exemplary OA333x1 physical layout prompt depicted in FIG. 3C. For each coordinate there is a corresponding net name, placed device, and the terminals (i.e., source, drain, gate) of the placed device. The net name and placed device are dummy values when there are no devices in the netlist being placed at the coordinate. The depicted column-based physical layout prompt structure facilitates identification of the common gate and diffusion connections of PMOS and NMOS devices by the large language model 208.

FIG. 3D depicts an example structure of a routability report prompt for a SEDFCNQD4T5Z3 standard cell (the OA333X1 standard cell may not comprise any unrouted nets). The exemplary prompt may be generated by one of the context extraction components 204.

The routability report prompt comprises a structure defining unrouted nets in the standard cell, the corresponding pairs of x-coordinates of net terminals, and the placed devices inside the unrouted region. These placed devices within the unrouted region provide the large language model 208 with context of routing congestion and required transistor pin access. This facilitates the identification of potential good cluster constraints by the large language model 208 to improve routability.

For example, if routing congestion or pin density is too high in an unrouted net region, leveraging common transistor terminal sharing across PMOS and NMOS, as well as diffusion sharing, may reduce pin density and routing resource usage by generating cluster constraints that consider the high connection nets or problematic nets of transistor pins in an unrouted net region.

The netlist tools 206 function cooperatively with the large language model 208 to generate the cluster constraints 108 and accurately identify sub-circuits in the ReAct prompts 210 reasoning and action loop. In one embodiment, the netlist tools 206 comprise a cluster evaluator 214, a component (group device retrieval 216) to retrieve group devices from nets, a component to save potential clusters (cluster saver 218), and a component to obtain the best cluster result (best cluster selector 220).

The cluster evaluator 214 evaluates the quality of the generated cluster constraint results using the simple cluster scores to account for the potential for diffusion sharing and common gates in the layout.

The simple cluster score may suffice for evaluation of the ReAct prompts when the time to launch layout generation is too long to collect accurate cell layout metrics (i.e., CW, TWL, etc.). The simple cluster score may be calculated using Equation (1) below. A higher score means the devices within each cluster may potentially be placed with greater common diffusion sharing and more common gates.

$$cluster\_score = {\sum }_{c ∈ C} ( \frac{{\sum }_{n ∈ {N}_{c}^{d}} ⌊ \frac{{P}_{n}}{2} ⌋ + ⌊ \frac{{N}_{n}}{2} ⌋}{{T}_{c}} + \frac{{\sum }_{n ∈ {N}_{c}^{g}} min ( {P}_{n} , {N}_{n} )}{{T}_{c}} ) \qquad ( 1 )$$

where c is a cluster in a set of clusters, C.

$${N}_{c}^{d} and {N}_{c}^{g}$$

represent the set or nets at diffusion (i.e., source or drain terminals), and gate in cluster c. Pₙ and Nₙ represents the number of nets n at PMOS and NMOS terminals, respectively. T_{c} is the number of transistors in cluster c. For potential diffusion sharing in a cluster, we calculate the number of same net pairs at diffusion terminals for PMOS and NMOS, respectively. The minimum number of the same gate nets of PMOS and NMOS is the potential number of common gates in a cluster.

The group device retrieval 216 netlist tool 206 returns the group of transistors from an arbitrary number of nets in the netlist 112. The large language model 208 may apply this tool to search and explore potential device clusters.

The cluster saver 218 tool returns the current clusters and cluster score for a new potential cluster generated by the large language model 208. The duplicated devices in different clusters are fixed based on the number of shared nets of these duplicated devices in each cluster.

The best cluster selector 220 tool returns the cluster result with the best simple cluster score (i.e., Equation (1)). It facilitates the large language model 208 reverting back or restarting the search from the previous best cluster result when it is stuck in the searching potential cluster phase.

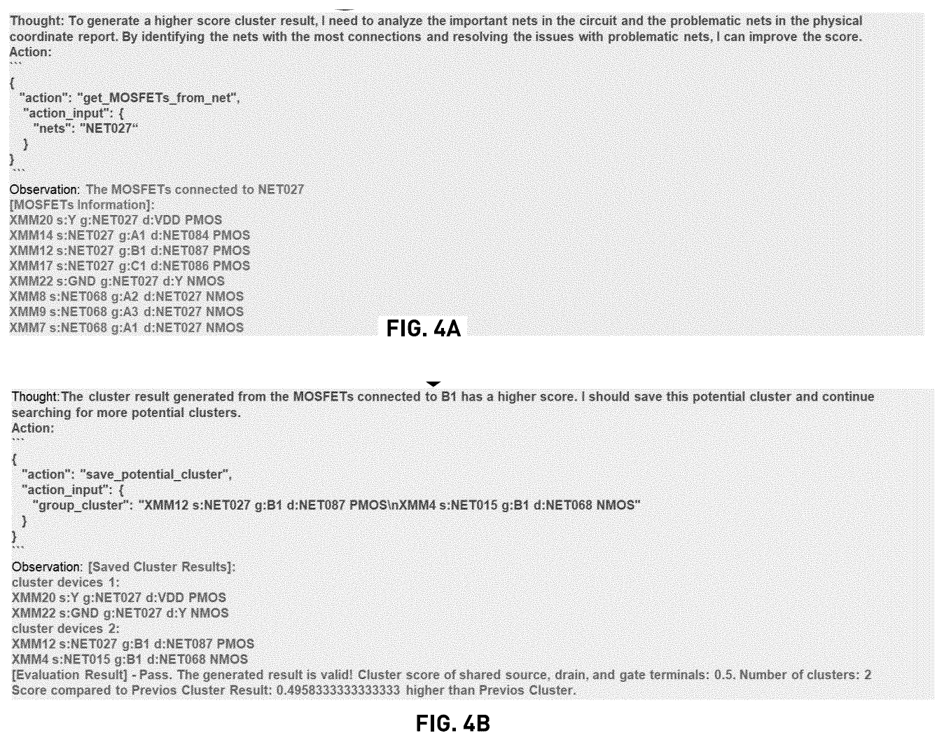

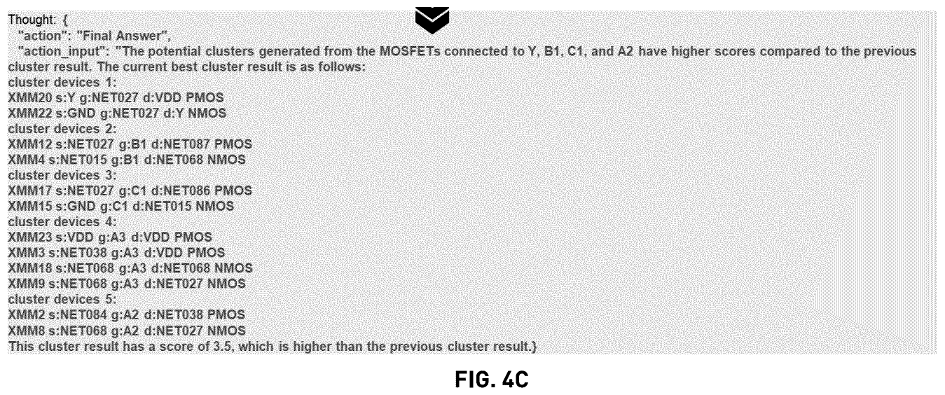

FIG. 4A-FIG. 4C depict an exemplary ReAct Thought-Action-Observation sequence. The response of the netlist tool 206 to an Action prompt becomes the Observation prompt for reasoning, e.g., generation of Thought prompts. The agent 102 continues the reasoning and action steps until selecting the “Final Answer” action.

The depicted ReAct sequence example works to optimize the cell area of a standard cell. Here, the agent starts with querying the group of devices connected to NET027 to explore good clusters incrementally to reduce the diffusion break for area reduction since NET027 is one of the high connection nets in the netlist topology and abutted to the diffusion break dummy device in the physical layout. Finally, the agent successfully generates high-quality cluster result through reasoning and leveraging the netlist tools traces in ReAct.

The mechanisms disclosed herein may be implemented in and/or by computing devices (e.g., as machine-readable instructions configuring a memory device) utilizing one or more graphic processing unit (GPU) and/or general purpose data processor (e.g., a ‘central processing unit’ or CPU). Exemplary architectures will now be described that may be configured to implement the mechanisms disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

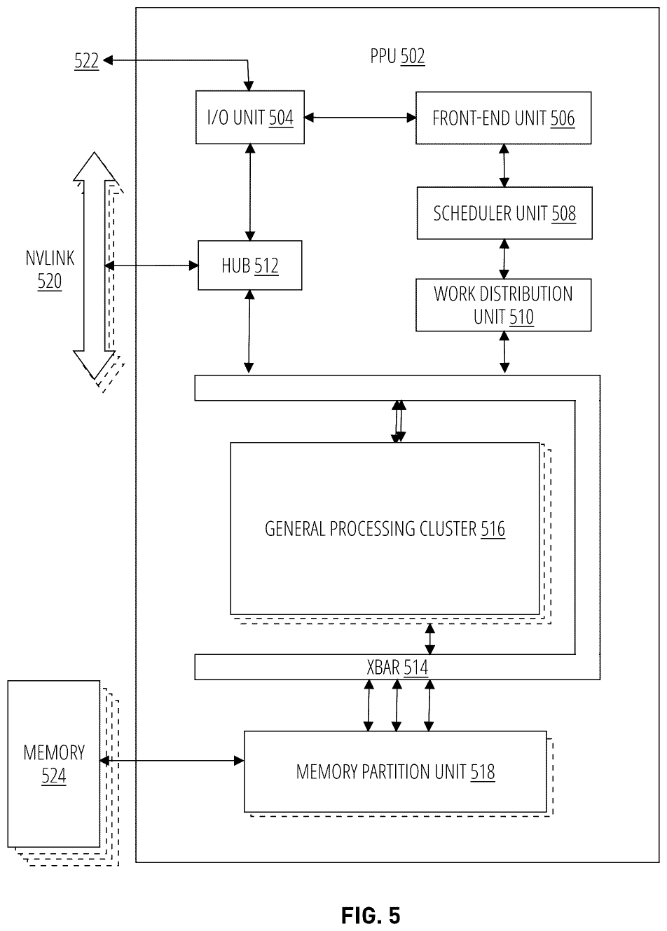

FIG. 5 depicts a parallel processing unit 502, in accordance with an embodiment. In an embodiment, the parallel processing unit 502 is a multi-threaded processor that is implemented on one or more integrated circuit devices. The parallel processing unit 502 is a latency hiding architecture designed to process many threads in parallel. A thread (e.g., a thread of execution) is an instantiation of a set of instructions configured to be executed by the parallel processing unit 502. In an embodiment, the parallel processing unit 502 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 502 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 502 modules may be configured to accelerate thousands of High Performance Computing (HPC), data center, and machine learning applications. The parallel processing unit 502 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the parallel processing unit 502 includes an I/O unit 504, a front-end unit 506, a scheduler unit 508, a work distribution unit 510, a hub 512, a crossbar 514, one or more general processing cluster 516 modules, and one or more memory partition unit 518 modules. The parallel processing unit 502 may be connected to a host processor or other parallel processing unit 502 modules via one or more high-speed NVLink 520 interconnects. The parallel processing unit 502 may be connected to a host processor or other peripheral devices via an interconnect 522. The parallel processing unit 502 may also be connected to a local memory comprising a number of memory 524 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 524 may comprise logic to configure the parallel processing unit 502 to carry out aspects of the techniques disclosed herein.

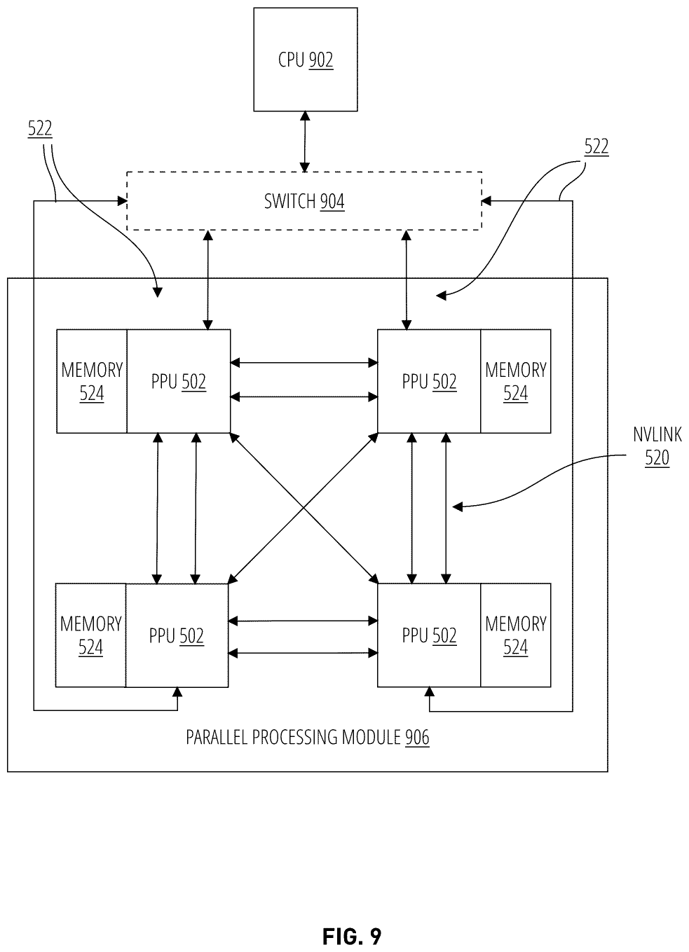

The NVLink 520 interconnect enables systems to scale and include one or more parallel processing unit 502 modules combined with one or more CPUs, supports cache coherence between the parallel processing unit 502 modules and CPUs, and CPU mastering. Data and/or commands may be transmitted by the NVLink 520 through the hub 512 to/from other units of the parallel processing unit 502 such as one or more copy engines, a video encoder, a video decoder, a power management unit, etc. (not explicitly shown). The NVLink 520 is described in more detail in conjunction with FIG. 9.

The I/O unit 504 is configured to transmit and receive communications (e.g., commands, data, etc.) from a host processor (not shown) over the interconnect 522. The I/O unit 504 may communicate with the host processor directly via the interconnect 522 or through one or more intermediate devices such as a memory bridge. In an embodiment, the I/O unit 504 may communicate with one or more other processors, such as one or more parallel processing unit 502 modules via the interconnect 522. In an embodiment, the I/O unit 504 implements a Peripheral Component Interconnect Express (PCIe) interface for communications over a PCIe bus and the interconnect 522 is a PCIe bus. In alternative embodiments, the I/O unit 504 may implement other types of well-known interfaces for communicating with external devices.

The I/O unit 504 decodes packets received via the interconnect 522. In an embodiment, the packets represent commands configured to cause the parallel processing unit 502 to perform various operations. The I/O unit 504 transmits the decoded commands to various other units of the parallel processing unit 502 as the commands may specify. For example, some commands may be transmitted to the front-end unit 506. Other commands may be transmitted to the hub 512 or other units of the parallel processing unit 502 such as one or more copy engines, a video encoder, a video decoder, a power management unit, etc. (not explicitly shown). In other words, the I/O unit 504 is configured to route communications between and among the various logical units of the parallel processing unit 502.

In an embodiment, a program executed by the host processor encodes a command stream in a buffer that provides workloads to the parallel processing unit 502 for processing. A workload may comprise several instructions and data to be processed by those instructions. The buffer is a region in a memory that is accessible (e.g., read/write) by both the host processor and the parallel processing unit 502. For example, the I/O unit 504 may be configured to access the buffer in a system memory connected to the interconnect 522 via memory requests transmitted over the interconnect 522. In an embodiment, the host processor writes the command stream to the buffer and then transmits a pointer to the start of the command stream to the parallel processing unit 502. The front-end unit 506 receives pointers to one or more command streams. The front-end unit 506 manages the one or more streams, reading commands from the streams and forwarding commands to the various units of the parallel processing unit 502.

The front-end unit 506 is coupled to a scheduler unit 508 that configures the various general processing cluster 516 modules to process tasks defined by the one or more streams. The scheduler unit 508 is configured to track state information related to the various tasks managed by the scheduler unit 508. The state may indicate which general processing cluster 516 a task is assigned to, whether the task is active or inactive, a priority level associated with the task, and so forth. The scheduler unit 508 manages the execution of a plurality of tasks on the one or more general processing cluster 516 modules.

The scheduler unit 508 is coupled to a work distribution unit 510 that is configured to dispatch tasks for execution on the general processing cluster 516 modules. The work distribution unit 510 may track a number of scheduled tasks received from the scheduler unit 508. In an embodiment, the work distribution unit 510 manages a pending task pool and an active task pool for each of the general processing cluster 516 modules. The pending task pool may comprise a number of slots (e.g., 32 slots) that contain tasks assigned to be processed by a particular general processing cluster 516. The active task pool may comprise a number of slots (e.g., 4 slots) for tasks that are actively being processed by the general processing cluster 516 modules. As a general processing cluster 516 finishes the execution of a task, that task is evicted from the active task pool for the general processing cluster 516 and one of the other tasks from the pending task pool is selected and scheduled for execution on the general processing cluster 516. If an active task has been idle on the general processing cluster 516, such as while waiting for a data dependency to be resolved, then the active task may be evicted from the general processing cluster 516 and returned to the pending task pool while another task in the pending task pool is selected and scheduled for execution on the general processing cluster 516.

The work distribution unit 510 communicates with the one or more general processing cluster 516 modules via crossbar 514. The crossbar 514 is an interconnect network that couples many of the units of the parallel processing unit 502 to other units of the parallel processing unit 502. For example, the crossbar 514 may be configured to couple the work distribution unit 510 to a particular general processing cluster 516. Although not shown explicitly, one or more other units of the parallel processing unit 502 may also be connected to the crossbar 514 via the hub 512.

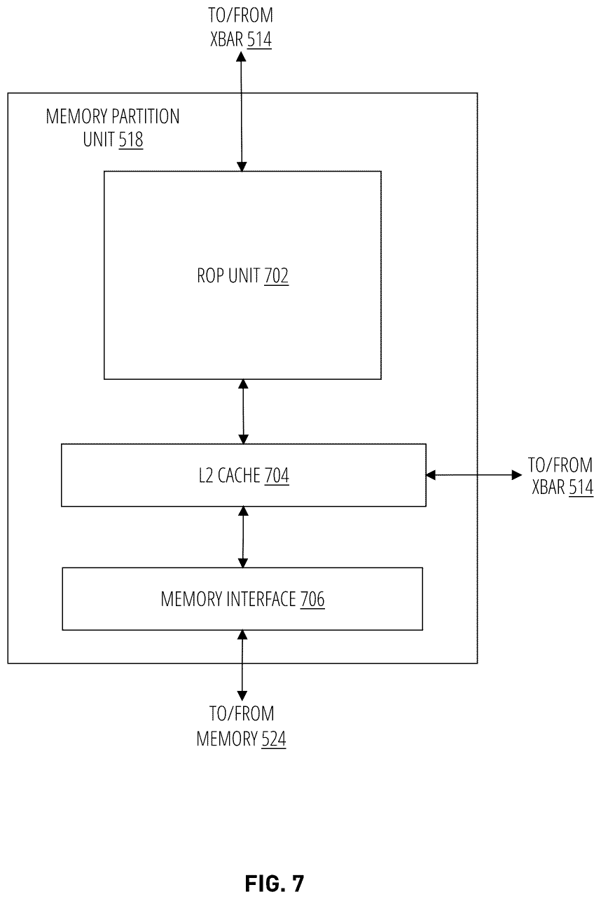

The tasks are managed by the scheduler unit 508 and dispatched to a general processing cluster 516 by the work distribution unit 510. The general processing cluster 516 is configured to process the task and generate results. The results may be consumed by other tasks within the general processing cluster 516, routed to a different general processing cluster 516 via the crossbar 514, or stored in the memory 524. The results can be written to the memory 524 via the memory partition unit 518 modules, which implement a memory interface for reading and writing data to/from the memory 524. The results can be transmitted to another parallel processing unit 502 or CPU via the NVLink 520. In an embodiment, the parallel processing unit 502 includes a number U of memory partition unit 518 modules that is equal to the number of separate and distinct memory 524 devices coupled to the parallel processing unit 502. A memory partition unit 518 will be described in more detail below in conjunction with FIG. 7.

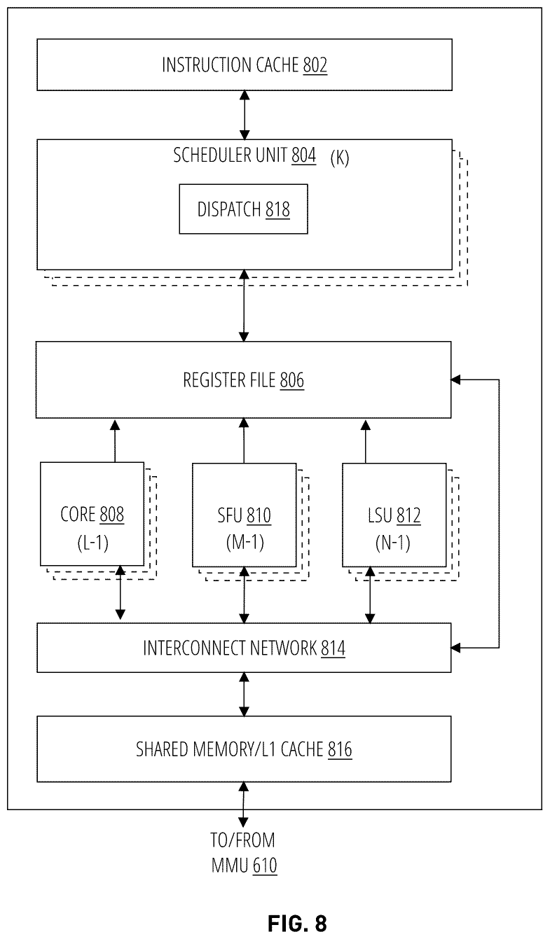

In an embodiment, a host processor executes a driver kernel that implements an application programming interface (API) that enables one or more applications executing on the host processor to schedule operations for execution on the parallel processing unit 502. In an embodiment, multiple compute applications are simultaneously executed by the parallel processing unit 502 and the parallel processing unit 502 provides isolation, quality of service (QoS), and independent address spaces for the multiple compute applications. An application may generate instructions (e.g., API calls) that cause the driver kernel to generate one or more tasks for execution by the parallel processing unit 502. The driver kernel outputs tasks to one or more streams being processed by the parallel processing unit 502. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8.

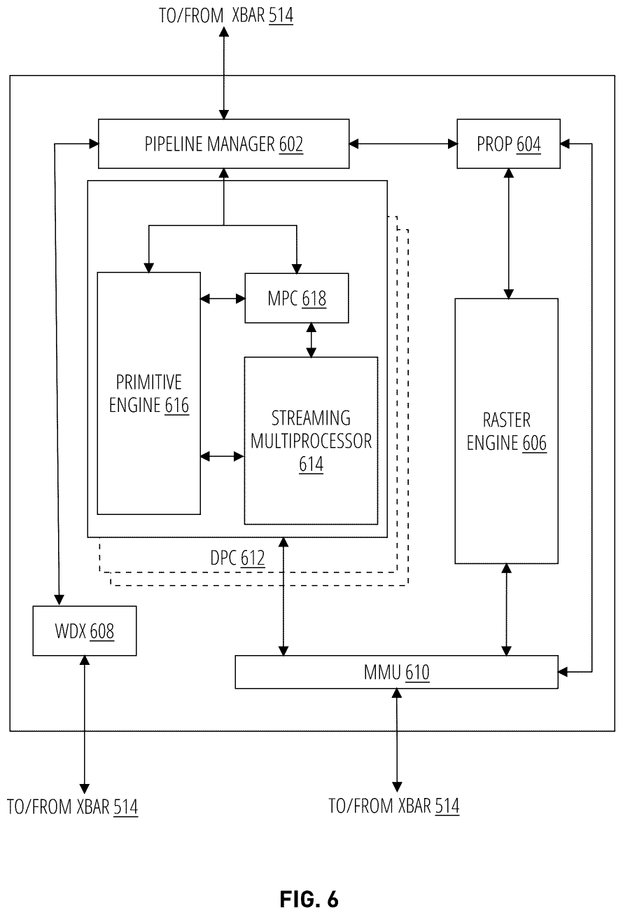

FIG. 6 depicts a general processing cluster 516 of the parallel processing unit 502 of FIG. 5, in accordance with an embodiment. As shown in FIG. 6, each general processing cluster 516 includes a number of hardware units for processing tasks. In an embodiment, each general processing cluster 516 includes a pipeline manager 602, a pre-raster operations unit 604, a raster engine 606, a work distribution crossbar 608, a memory management unit 610, and one or more data processing cluster 612. It will be appreciated that the general processing cluster 516 of FIG. 6 may include other hardware units in lieu of or in addition to the units shown in FIG. 6.

In an embodiment, the operation of the general processing cluster 516 is controlled by the pipeline manager 602. The pipeline manager 602 manages the configuration of the one or more data processing cluster 612 modules for processing tasks allocated to the general processing cluster 516. In an embodiment, the pipeline manager 602 may configure at least one of the one or more data processing cluster 612 modules to implement at least a portion of a graphics rendering pipeline. For example, a data processing cluster 612 may be configured to execute a vertex shader program on the programmable streaming multiprocessor 614. The pipeline manager 602 may also be configured to route packets received from the work distribution unit 510 to the appropriate logical units within the general processing cluster 516. For example, some packets may be routed to fixed function hardware units in the pre-raster operations unit 604 and/or raster engine 606 while other packets may be routed to the data processing cluster 612 modules for processing by the primitive engine 616 or the streaming multiprocessor 614. In an embodiment, the pipeline manager 602 may configure at least one of the one or more data processing cluster 612 modules to implement a neural network model and/or a computing pipeline.

The pre-raster operations unit 604 is configured to route data generated by the raster engine 606 and the data processing cluster 612 modules to a Raster Operations (ROP) unit, described in more detail in conjunction with FIG. 7. The pre-raster operations unit 604 may also be configured to perform optimizations for color blending, organize pixel data, perform address translations, and the like.

The raster engine 606 includes a number of fixed function hardware units configured to perform various raster operations. In an embodiment, the raster engine 606 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 606 comprises fragments to be processed, for example, by a fragment shader implemented within a data processing cluster 612.

Each data processing cluster 612 included in the general processing cluster 516 includes an M-pipe controller 618, a primitive engine 616, and one or more streaming multiprocessor 614 modules. The M-pipe controller 618 controls the operation of the data processing cluster 612, routing packets received from the pipeline manager 602 to the appropriate units in the data processing cluster 612. For example, packets associated with a vertex may be routed to the primitive engine 616, which is configured to fetch vertex attributes associated with the vertex from the memory 524. In contrast, packets associated with a shader program may be transmitted to the streaming multiprocessor 614.

The streaming multiprocessor 614 comprises a programmable streaming processor that is configured to process tasks represented by a number of threads. Each streaming multiprocessor 614 is multi-threaded and configured to execute a plurality of threads (e.g., 32 threads) from a particular group of threads concurrently. In an embodiment, the streaming multiprocessor 614 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 614 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 614 will be described in more detail below in conjunction with FIG. 8.

The memory management unit 610 provides an interface between the general processing cluster 516 and the memory partition unit 518. The memory management unit 610 may provide translation of virtual addresses into physical addresses, memory protection, and arbitration of memory requests. In an embodiment, the memory management unit 610 provides one or more translation lookaside buffers (TLBs) for performing translation of virtual addresses into physical addresses in the memory 524.

FIG. 7 depicts a memory partition unit 518 of the parallel processing unit 502 of FIG. 5, in accordance with an embodiment. As shown in FIG. 7, the memory partition unit 518 includes a raster operations unit 702, a level two cache 704, and a memory interface 706. The memory interface 706 is coupled to the memory 524. Memory interface 706 may implement 32, 64, 128, 1024-bit data buses, or the like, for high-speed data transfer. In an embodiment, the parallel processing unit 502 incorporates U memory interface 706 modules, one memory interface 706 per pair of memory partition unit 518 modules, where each pair of memory partition unit 518 modules is connected to a corresponding memory 524 device. For example, parallel processing unit 502 may be connected to up to Y memory 524 devices, such as high bandwidth memory stacks or graphics double-data-rate, version 5, synchronous dynamic random access memory, or other types of persistent storage.

In an embodiment, the memory interface 706 implements an HBM2 memory interface and Y equals half U. In an embodiment, the HBM2 memory stacks are located on the same physical package as the parallel processing unit 502, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 524 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 502 modules process very large datasets and/or run applications for extended periods.

In an embodiment, the parallel processing unit 502 implements a multi-level memory hierarchy. In an embodiment, the memory partition unit 518 supports a unified memory to provide a single unified virtual address space for CPU and parallel processing unit 502 memory, enabling data sharing between virtual memory systems. In an embodiment the frequency of accesses by a parallel processing unit 502 to memory located on other processors is traced to ensure that memory pages are moved to the physical memory of the parallel processing unit 502 that is accessing the pages more frequently. In an embodiment, the NVLink 520 supports address translation services allowing the parallel processing unit 502 to directly access a CPU's page tables and providing full access to CPU memory by the parallel processing unit 502.

In an embodiment, copy engines transfer data between multiple parallel processing unit 502 modules or between parallel processing unit 502 modules and CPUs. The copy engines can generate page faults for addresses that are not mapped into the page tables. The memory partition unit 518 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 524 or other system memory may be fetched by the memory partition unit 518 and stored in the level two cache 704, which is located on-chip and is shared between the various general processing cluster 516 modules. As shown, each memory partition unit 518 includes a portion of the level two cache 704 associated with a corresponding memory 524 device. Lower level caches may then be implemented in various units within the general processing cluster 516 modules. For example, each of the streaming multiprocessor 614 modules may implement an L1 cache. The L1 cache is private memory that is dedicated to a particular streaming multiprocessor 614. Data from the level two cache 704 may be fetched and stored in each of the L1 caches for processing in the functional units of the streaming multiprocessor 614 modules. The level two cache 704 is coupled to the memory interface 706 and the crossbar 514.

The raster operations unit 702 performs graphics raster operations related to pixel color, such as color compression, pixel blending, and the like. The raster operations unit 702 also implements depth testing in conjunction with the raster engine 606, receiving a depth for a sample location associated with a pixel fragment from the culling engine of the raster engine 606. The depth is tested against a corresponding depth in a depth buffer for a sample location associated with the fragment. If the fragment passes the depth test for the sample location, then the raster operations unit 702 updates the depth buffer and transmits a result of the depth test to the raster engine 606. It will be appreciated that the number of partition memory partition unit 518 modules may be different than the number of general processing cluster 516 modules and, therefore, each raster operations unit 702 may be coupled to each of the general processing cluster 516 modules. The raster operations unit 702 tracks packets received from the different general processing cluster 516 modules and determines which general processing cluster 1 that a result generated by the raster operations unit 702 is routed to through the crossbar 514. Although the raster operations unit 702 is included within the memory partition unit 518 in FIG. 7, in other embodiment, the raster operations unit 702 may be outside of the memory partition unit 518. For example, the raster operations unit 702 may reside in the general processing cluster 516 or another unit.

FIG. 8 illustrates the streaming multiprocessor 614 of FIG. 6, in accordance with an embodiment. As shown in FIG. 8, the streaming multiprocessor 614 includes an instruction cache 802, one or more scheduler unit 804 modules (e.g., such as scheduler unit 508), a register file 806, one or more processing core 808 modules, one or more special function unit 810 modules, one or more load/store unit 812 modules, an interconnect network 814, and a shared memory/L1 cache 816.

As described above, the work distribution unit 510 dispatches tasks for execution on the general processing cluster 516 modules of the parallel processing unit 502. The tasks are allocated to a particular data processing cluster 612 within a general processing cluster 516 and, if the task is associated with a shader program, the task may be allocated to a streaming multiprocessor 614. The scheduler unit 508 receives the tasks from the work distribution unit 510 and manages instruction scheduling for one or more thread blocks assigned to the streaming multiprocessor 614. The scheduler unit 804 schedules thread blocks for execution as warps of parallel threads, where each thread block is allocated at least one warp. In an embodiment, each warp executes 32 threads. The scheduler unit 804 may manage a plurality of different thread blocks, allocating the warps to the different thread blocks and then dispatching instructions from the plurality of different cooperative groups to the various functional units (e.g., core 808 modules, special function unit 810 modules, and load/store unit 812 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 818 unit is configured within the scheduler unit 804 to transmit instructions to one or more of the functional units. In one embodiment, the scheduler unit 804 includes two dispatch 818 units that enable two different instructions from the same warp to be dispatched during each clock cycle. In alternative embodiments, each scheduler unit 804 may include a single dispatch 818 unit or additional dispatch 818 units.

Each streaming multiprocessor 614 includes a register file 806 that provides a set of registers for the functional units of the streaming multiprocessor 614. In an embodiment, the register file 806 is divided between each of the functional units such that each functional unit is allocated a dedicated portion of the register file 806. In another embodiment, the register file 806 is divided between the different warps being executed by the streaming multiprocessor 614. The register file 806 provides temporary storage for operands connected to the data paths of the functional units.

Each streaming multiprocessor 614 comprises L processing core 808 modules. In an embodiment, the streaming multiprocessor 614 includes a large number (e.g., 128, etc.) of distinct processing core 808 modules. Each core 808 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 808 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 808 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 614 also comprises M special function unit 810 modules that perform special functions (e.g., attribute evaluation, reciprocal square root, and the like). In an embodiment, the special function unit 810 modules may include a tree traversal unit configured to traverse a hierarchical tree data structure. In an embodiment, the special function unit 810 modules may include texture unit configured to perform texture map filtering operations. In an embodiment, the texture units are configured to load texture maps (e.g., a 2D array of texels) from the memory 524 and sample the texture maps to produce sampled texture values for use in shader programs executed by the streaming multiprocessor 614. In an embodiment, the texture maps are stored in the shared memory/L1 cache 816. The texture units implement texture operations such as filtering operations using mip-maps (e.g., texture maps of varying levels of detail). In an embodiment, each streaming multiprocessor 614 includes two texture units.

Each streaming multiprocessor 614 also comprises N load/store unit 812 modules that implement load and store operations between the shared memory/L1 cache 816 and the register file 806. Each streaming multiprocessor 614 includes an interconnect network 814 that connects each of the functional units to the register file 806 and the load/store unit 812 to the register file 806 and shared memory/L1 cache 816. In an embodiment, the interconnect network 814 is a crossbar that can be configured to connect any of the functional units to any of the registers in the register file 806 and connect the load/store unit 812 modules to the register file 806 and memory locations in shared memory/L1 cache 816.

The shared memory/L1 cache 816 is an array of on-chip memory that allows for data storage and communication between the streaming multiprocessor 614 and the primitive engine 616 and between threads in the streaming multiprocessor 614. In an embodiment, the shared memory/L1 cache 816 comprises 128 KB of storage capacity and is in the path from the streaming multiprocessor 614 to the memory partition unit 518. The shared memory/L1 cache 816 can be used to cache reads and writes. One or more of the shared memory/L1 cache 816, level two cache 704, and memory 524 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 816 enables the shared memory/L1 cache 816 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 510 assigns and distributes blocks of threads directly to the data processing cluster 612 modules. The threads in a block execute the same program, using a unique thread ID in the calculation to ensure each thread generates unique results, using the streaming multiprocessor 614 to execute the program and perform calculations, shared memory/L1 cache 816 to communicate between threads, and the load/store unit 812 to read and write global memory through the shared memory/L1 cache 816 and the memory partition unit 518. When configured for general purpose parallel computation, the streaming multiprocessor 614 can also write commands that the scheduler unit 508 can use to launch new work on the data processing cluster 612 modules.

The parallel processing unit 502 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 502 is embodied on a single semiconductor substrate. In another embodiment, the parallel processing unit 502 is included in a system-on-a-chip (SoC) along with one or more other devices such as additional parallel processing unit 502 modules, the memory 524, a reduced instruction set computer (RISC) CPU, a memory management unit (MMU), a digital-to-analog converter (DAC), and the like.

In an embodiment, the parallel processing unit 502 may be included on a graphics card that includes one or more memory devices. The graphics card may be configured to interface with a PCIe slot on a motherboard of a desktop computer. In yet another embodiment, the parallel processing unit 502 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 9 is a conceptual diagram of a processing system implemented using the parallel processing unit 502 of FIG. 5, in accordance with an embodiment. The processing system includes a central processing unit 902, an switch 904, and multiple parallel processing unit 502 modules each and respective memory 524 modules. The switch 904 is depicted with dashed lines, indicating that it is optional in some embodiments.

The NVLink 520 provides high-speed communication links between each of the parallel processing unit 502 modules. Although a particular number of NVLink 520 and interconnect 522 connections are illustrated in FIG. 9, the number of connections to each parallel processing unit 502 and the central processing unit 902 may vary. The switch 904 interfaces between the interconnect 522 and the central processing unit 902. The parallel processing unit 502 modules, memory 524 modules, and NVLink 520 connections may be situated on a single semiconductor platform to form a parallel processing module 906. In an embodiment, the switch 904 supports two or more protocols to interface between various different connections and/or links.

In another embodiment (not shown), the NVLink 520 provides one or more high-speed communication links between each of the parallel processing unit modules (parallel processing unit 502, parallel processing unit 502, parallel processing unit 502, and parallel processing unit 502) and the central processing unit 902 and the switch 904 (when present) interfaces between the interconnect 522 and each of the parallel processing unit modules. The parallel processing unit modules, memory 524 modules, and interconnect 522 may be situated on a single semiconductor platform to form a parallel processing module 906. In yet another embodiment (not shown), the interconnect 522 provides one or more communication links between each of the parallel processing unit modules and the central processing unit 902 and the switch 904 interfaces between each of the parallel processing unit modules using the NVLink 520 to provide one or more high-speed communication links between the parallel processing unit modules. In another embodiment (not shown), the NVLink 520 provides one or more high-speed communication links between the parallel processing unit modules and the central processing unit 902 through the switch 904. In yet another embodiment (not shown), the interconnect 522 provides one or more communication links between each of the parallel processing unit modules directly. One or more of the NVLink 520 high-speed communication links may be implemented as a physical NVLink interconnect or either an on-chip or on-die interconnect using the same protocol as the NVLink 520.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 906 may be implemented as a circuit board substrate and each of the parallel processing unit modules and/or memory 524 modules may be packaged devices. In an embodiment, the central processing unit 902, switch 904, and the parallel processing module 906 are situated on a single semiconductor platform.

In an embodiment, each parallel processing unit module includes six NVLink 520 interfaces (as shown in FIG. 9, five NVLink 520 interfaces are included for each parallel processing unit module). The NVLink 520 may be operated exclusively for PPU-to-PPU communication as shown in FIG. 9, or some combination of PPU-to-PPU and PPU-to-CPU, when the central processing unit 902 also includes one or more NVLink 520 interfaces.

In an embodiment, the NVLink 520 allows direct load/store/atomic access from the central processing unit 902 to each parallel processing unit module's memory 524. In an embodiment, the NVLink 520 supports coherency operations, allowing data read from the memory 524 modules to be stored in the cache hierarchy of the central processing unit 902, reducing cache access latency for the central processing unit 902. In an embodiment, the NVLink 520 includes support for Address Translation Services (ATS), enabling the parallel processing unit module to directly access page tables within the central processing unit 902. One or more of the NVLink 520 may also be configured to operate in a low-power mode.

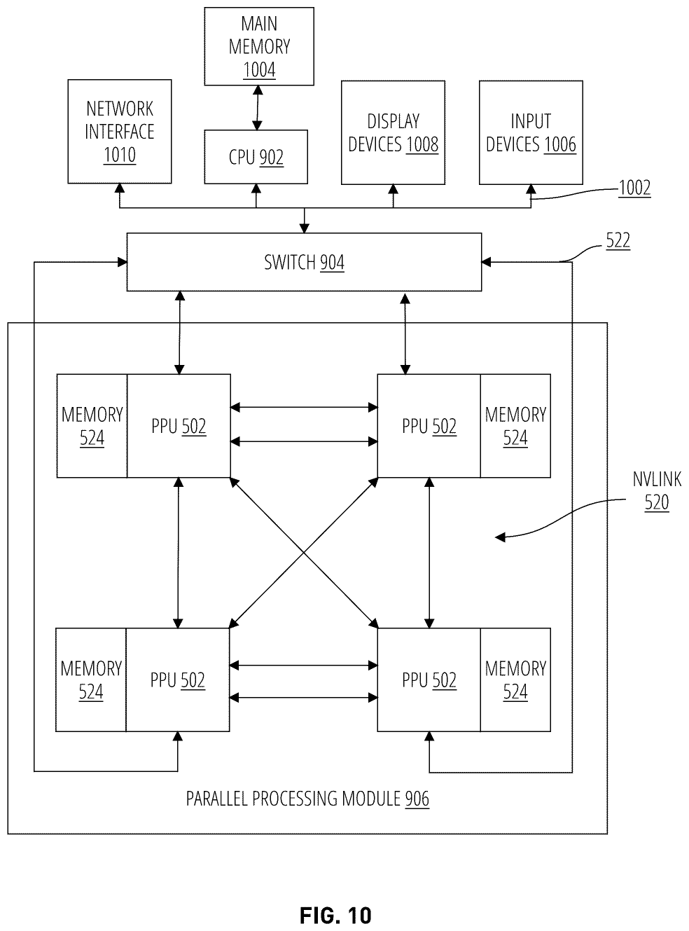

FIG. 10 depicts an exemplary processing system in which the various architecture and/or functionality of the various previous embodiments may be implemented. As shown, an exemplary processing system is provided including at least one central processing unit 902 that is connected to a communications bus 1002. The communication communications bus 1002 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1004. Control logic (software) and data are stored in the main memory 1004 which may take the form of random access memory (RAM).

The exemplary processing system also includes input devices 1006, the parallel processing module 906, and display devices 1008, e.g. a conventional CRT (cathode ray tube), LCD (liquid crystal display), LED (light emitting diode), plasma display or the like. User input may be received from the input devices 1006, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1010 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1004 and/or the secondary storage. Such computer programs, when executed, enable the exemplary processing system to perform various functions. The main memory 1004, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 agent
104 standard cell layout logic
106 layout
108 cluster constraint
110 optimized layout
112 netlist
202 routability
204 context extraction component
206 netlist tool
208 large language model
210 ReAct prompt
212 query and context prompt
214 cluster evaluator
216 group device retrieval
218 cluster saver
220 best cluster selector
502 parallel processing unit
504 I/O unit
506 front-end unit
508 scheduler unit
510 work distribution unit
512 hub
514 crossbar
516 general processing cluster
518 memory partition unit
520 NVLink
522 interconnect
524 memory
602 pipeline manager
604 pre-raster operations unit
606 raster engine
608 work distribution crossbar
610 memory management unit
612 data processing cluster
614 streaming multiprocessor
616 primitive engine
618 M-pipe controller
702 raster operations unit
704 level two cache
706 memory interface
802 instruction cache
804 scheduler unit
806 register file
808 core
810 special function unit
812 load/store unit
814 interconnect network
816 shared memory/L1 cache
818 dispatch
902 central processing unit
904 switch
906 parallel processing module
1002 communications bus
1004 main memory
1006 input devices
1008 display devices
1010 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A system comprising:
a circuit layout tool configured to generate a layout for a circuit based on input cluster constraints; and
a feedback loop comprising an agent configured to operate a large language model in a Thought-Action-Observation (ReAct) prompting loop to update the cluster constraints and to apply the updated cluster constraints to the circuit layout tool.

2. The system of claim 1, wherein the large language model is configured to generate cluster constraints to optimize performance, power, and area of the circuit.

3. The system of claim 1, wherein the circuit is a standard cell.

4. The system of claim 1, further comprising logic to form prompts of the ReAct prompting loop from a netlist for the circuit and a physical layout for the circuit.

5. The system of claim 4, further configured such that the netlist and the physical layout are combined with a query to the large language model.

6. The system of claim 4, further comprising logic to form the prompts from a routability report for the physical layout.

7. The system of claim 1, wherein the large language model is configured to generate actions of the ReAct prompting loop to a netlist tool.

8. The system of claim 7, wherein the netlist tool comprising one or more of a cluster evaluator tool, a device group retrieval tool, a cluster saving tool, and a best cluster selection tool.

9. A process for manufacturing an integrated circuit, the process comprising:
operating a circuit layout tool to generate a layout for the integrated circuit based on input cluster constraints;
operating an agent configured to drive a large language model in a Thought-Action-Observation (ReAct) prompting loop to update the cluster constraints; and
applying the updated cluster constraints to the circuit layout tool to generate an updated layout for the integrated circuit.

10. The process of claim 9, wherein the large language model generates cluster constraints to optimize performance, power, and area of the integrated circuit.

11. The process of claim 9, wherein the integrated circuit is a standard cell.

12. The process of claim 9, further comprising forming prompts of the ReAct prompting loop from a netlist for the integrated circuit and a physical layout for the integrated circuit.

13. The process of claim 12, wherein the netlist and the physical layout are combined with a query to the large language model.

14. The process of claim 12, further comprising forming the prompts from a routability report for the physical layout.

15. The process of claim 9, wherein the large language model generate actions of the ReAct prompting loop to a netlist tool.

16. The process of claim 15, the netlist tool comprising one or more of a cluster evaluator tool, a device group retrieval tool, a cluster saving tool, and a best cluster selection tool.

17. A non-volatile machine-readable media comprising instructions that, when applied to a data processor, configure one or more data processors to:
operate a circuit layout tool to generate a layout for a circuit based on input cluster constraints for the layout;
operate an agent configured to drive a large language model in a Thought-Action-Observation (ReAct) prompting loop to update the cluster constraints; and
apply the updated cluster constraints to the circuit layout tool to generate an updated layout for the circuit.

18. The non-volatile machine-readable media of claim 17, further comprising instructions that, when applied to the one or more data processors, configure the one or more data processors to:
form prompts of the ReAct prompting loop from a routability report for the physical layout.

19. The non-volatile machine-readable media of claim 17, further comprising instructions that, when applied to the one or more data processors, configure the one or more data processors to:
form prompts of the ReAct prompting loop from a netlist for the circuit and a physical layout for the circuit.

20. The non-volatile machine-readable media of claim 19, further comprising instructions that, when applied to the one or more data processors, configure the one or more data processors to:
combine the netlist and the physical layout with a query to the large language model.
